(19) United States
(12) Patent Application Publication
(10) Pub. No.: US 2018/0322489 A1
(43) Pub. Date: Nov. 8, 2018

(54) SYSTEM AND METHOD FOR RESTRICTED TRANSACTION PROCESSING

(71) Applicants: Meredith Altenhofen, San Francisco, CA (US); Chris Truelson, Highlands Ranch, CO (US); Quan Wang, Foster City, CA (US)

(72) Inventors: Meredith Altenhofen, San Francisco, CA (US); Chris Truelson, Highlands Ranch, CO (US); Quan Wang, Foster City, CA (US)

(21) Appl. No.: 15/585,674

(22) Filed: May 3, 2017

(51) Int. Cl. G06Q 20/38

(52) U.S. Cl. CPC G06Q 20/3821

(57) ABSTRACT

According to some embodiments of the invention, both open loop and closed loop processing may be implemented by a transaction processor. For general, unrestricted transactions, the transaction processor may direct authorization to an open loop primary authorizing entity associated with a primary account number (PAN). For restricted transactions, the transaction processor may determine the appropriate closed loop authorizing entity (e.g., a transit agency, an insurer, a retailer, etc.). The transaction processor may further create an entry in a multi-access blockchain evidencing the transaction on the closed loop or restricted account with that authorizing entity. Thus, the multi-access blockchain may be kept up-to-date, allowing the closed loop authorizing entities to verify transactions and account balances instantaneously.

### CROSS-REFERENCES TO RELATED APPLICATIONS

None.

### BACKGROUND

Many entities implement closed loop systems using single purpose membership cards. Closed loop systems may be systems that limit use of the card to a specific entity and require users to hold a unique, dedicated account maintained by that entity. This may make it easy for an entity to track and limit use of the membership card. Limited use of the membership card may be required in order to associate restricted government- or employer-subsidized benefits with the card in order to ensure that the benefits are not used for an improper purpose. Exemplary entities that may traditionally implement closed loop systems include transit agencies and insurers. Due to the nature of the closed loop system, therefore, users may need to carry a large number of different membership cards for different uses (e.g., at least one separate membership card per closed loop entity).

In response to this, some entities have moved toward implementing open loop systems using multipurpose membership cards. Open loop systems may be systems that allow users to use a single membership card for multiple purposes and/or at multiple entities. Open loop transactions may be run through traditional transaction processing channels (e.g., by sending an authorization request message through a transaction processor to an authorizing entity). Such open loop systems allow users to reduce the number of membership cards needed to be carried. However, restricted benefits (e.g., government- and employer-subsidized benefits) cannot be added to existing open loop, multipurpose cards, as use of the benefits would be unrestricted and unregulated.

In addition, neither existing dosed loop systems nor existing open loop systems are capable of processing joint restricted and unrestricted transactions. For example, a membership card associated with a transit account cannot be used both to gain access to a transit station and to initiate a transaction with a retailer at the transit station. Instead, two separate transactions would need to be performed: a first transaction to gain access to the transit station with a closed loop transit card, and a second transaction to complete the transaction with the retailer with an open loop card. In an open loop system, a single open loop card may be used to both access the transit station and transact with the retailer. However, both the access transaction and the retailer transaction would be performed as unrestricted transactions, leaving restricted benefits unused.

In addition, both closed loop and open loop entities may use traditional databases to keep records of transactions performed on user accounts. Each entity may own and/or control its own centralized database. These databases may be easily changed, updated, and/or rewritten, such that transaction data may be tampered with or lost. Therefore, a complete history of all of the transactions performed on the account may not be maintained.

Embodiments of the invention address this and other problems, individually and collectively.

### SUMMARY

According to some embodiments of the invention, a method is provided. The method comprises receiving, at a server computer, a request to process an interaction between a user and a first authorizing entity computer. The request includes a first value, a credential, and a flag. The method further comprises determining, by the server computer, that the flag is in the request. In response to determining that the flag is in the request, the method further comprises determining, by the server computer, an identity of the first authorizing entity computer using the flag. The method further comprises accessing, by the server computer, a multi-access blockchain. The multi-access blockchain stores data representing a plurality of interactions between a plurality of first authorizing entity computers and a plurality of users. The method further comprises retrieving, by the server computer, a second value associated with the user and the first authorizing entity computer from the multi-access blockchain based on the identity. The method further comprises determining, by the server computer, that the second value is less than the first value. The method further comprises determining, by the server computer, a primary authorizing entity computer based on the credential. The method further comprises determining, by the server computer, that the primary authorizing entity computer is capable of authorizing a third value. The third value is the different between the first value and the second value. The method further comprises creating, by the server computer, an entry recording the interaction in the multi-access blockchain. The entry includes the second value and the third value. The method further comprises facilitating, by the server computer, processing of the third value by the primary authorizing entity computer.

Embodiments of the invention are further directed to a server computer comprising a processor and a memory coupled to the processor. The memory can store instructions, executable by the processor, for implementing the methods described herein.

These and other embodiments of the invention are described in further detail below.

### BRIEF DESCRIPTION OF THE DRAWINGS

FIG. 1 shows a block diagram of a closed loop system according to some embodiments of the present invention.

FIG. 2 shows a flow diagram of a method for funding a closed loop payment card and processing a transaction using the closed loop payment card in a closed loop system according to some embodiments of the present invention.

FIG. 3 shows a block diagram of a system for dual transaction processing according to some embodiments of the present invention.

FIG. 4 shows a block diagram of a transaction processing computer according to some embodiments of the present invention.

FIG. 5 shows a block diagram of a qualification engine according to some embodiments of the present invention.

FIG. 6 shows a block diagram of a message routing engine according to some embodiments of the present invention.

FIG. 7 shows a block diagram of a translation engine according to sonic embodiments of the present invention.

FIG. 8 shows a block diagram of a first authorizing entity computer according to some embodiments of the present invention.

FIG. 9 shows a block diagram of a multi-access blockchain according to some embodiments of the present invention.

FIG. 10 shows a flow diagram of a method for dual transaction processing according to some embodiments of the present invention.

### DETAILED DESCRIPTION

According to some embodiments of the invention, both open loop and closed loop processing may be implemented by a transaction processor in a dual processing system. For general, unrestricted transactions, the transaction processor may direct authorization to an open loop primary authorizing entity associated with a primary account number (PAN). For restricted transactions, the transaction processor may determine the appropriate closed loop authorizing entity (e.g., a transit agency, an insurer, a retailer, etc.). The transaction processor may further create an entry in a multi-access blockchain evidencing the transaction on the closed loop or restricted account with that authorizing entity. Thus, the multi-access blockchain may be kept up-to-date, allowing the closed loop authorizing entities to verify transactions and account balances instantaneously. In some embodiments, the open loop authorizing entities may maintain their transactions on the multi-access blockchain as well.

Before discussing specific embodiments and examples, some descriptions of terms used herein are provided below.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. The POS terminal may or may not initiate processing of transactions.

An “authorization request message” may be a message that requests authorization for a particular event. For example, an authorization request message may request authorization to perform a payment transaction. In some embodiments, an authorization request message may comply with International Organization of Standardization (ISO) 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCW (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

An “authorizing entity” may be an entity that authorizes a request. Examples of an authorizing entity may be an issuer, a governmental agency, a document repository, an access administrator, etc.

A “blockchain” can be a distributed database that maintains a continuously-growing list of records secured from tampering and revision. A blockchain may include a number of blocks of interaction records. Each block in the blockchain can contain also include a timestamp and a link to a previous block. For example, each block may include or be appended to a hash of the previous block. Stated differently, interaction records in a blockchain may be stored as a series of “blocks,” or permanent files that include a record of a number of transactions occurring over a given period of time. Blocks may be appended to a blockchain by an appropriate node after it completes the block and the block is validated. In embodiments of the invention, a blockchain may be distributed, and a copy of the blockchain may be maintained at each node in a verification network. Any node within the verification network may subsequently use the blockchain to verify transactions. The security of a blockchain may be obtained using a cryptographic scheme. For example, an individual can be prevented from adding a block to the block chain unless they encrypt the block using an cryptographic algorithm. The cryptographic algorithm may be a function that receives a message or hash along with a cryptograph key and then outputs an encrypted message.

A “credential” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or a payment device associated with the account). Such information may be directly related to the account or may be derived from information related to the account. Examples of account information may include an “account identifier” such as a PAN (primary account number or “account number”), an eID, a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

An “electronic identity” or “eID” may be any suitable string of characters or symbols used to identify an entity (e.g., a person or device). In some embodiments, the electronic identity may be mathematically derived from information associated with a user. For example, in some embodiments, an electronic identity may be a value calculated by hashing one or more input values (e.g., name, country code, etc.) available to multiple entities. In this way, the electronic identity may be independently generated by any entity that has the prerequisite information. An electronic identity may be altered (e.g., hashed and/or encrypted) information associated with a user. For example, in some embodiments, an electronic identity may be derived from a combination of a country code, a name, date of birth, and last four digits of a social security number such as SHA256 (USA*JOHN SMITH*19700101*1234). Hashing this value may result in a seemingly random string of characters, such as 754WD2E2513BF546050C2D079FF5D65AB6E318E. In some embodiments, the electronic identity is associated with a passphrase that must be provided in order to access any interaction record associated with the electronic identity. An electronic identity may sometimes be referred to as an “eID” or electronic identifier.

A “flag” may be any letter(s), number(s) and/or symbol(s), or combinations thereof, that can be used to identify the presence of a condition or an action to be taken. For example, a flag may be a check mark under a given category of transaction. In another example, a flag may be a code (e.g., “4111”) that corresponds to a particular category of transaction, such as a merchant category code or merchant identifier.

A “portable device” is any device that may be used to initiate a transaction. In the payment context, for example, a portable device may be a credit card, a debit card, a gift card, an electronic device (e.g., a communication device such as a mobile phone, a wearable device, etc.) provisioned with payment credentials, and the like.

A “resource provider” may be an entity that can provide a resource such as goods, services, information, and/or access. Examples of a resource provider include merchants, access devices, secure data access points, etc. A “merchant” may typically be an entity that engages in transactions and can sell goods or services, or provide access to goods or services.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “transaction processing computer” may include a network of one or more devices that can process and route transaction request messages. An exemplary transaction processing computer may include data processing subsystems, networks, and operations used to support and deliver authorization services, exception file services, transaction scoring services, and clearing and settlement services. An exemplary transaction processing system may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

### I. Closed Loop System

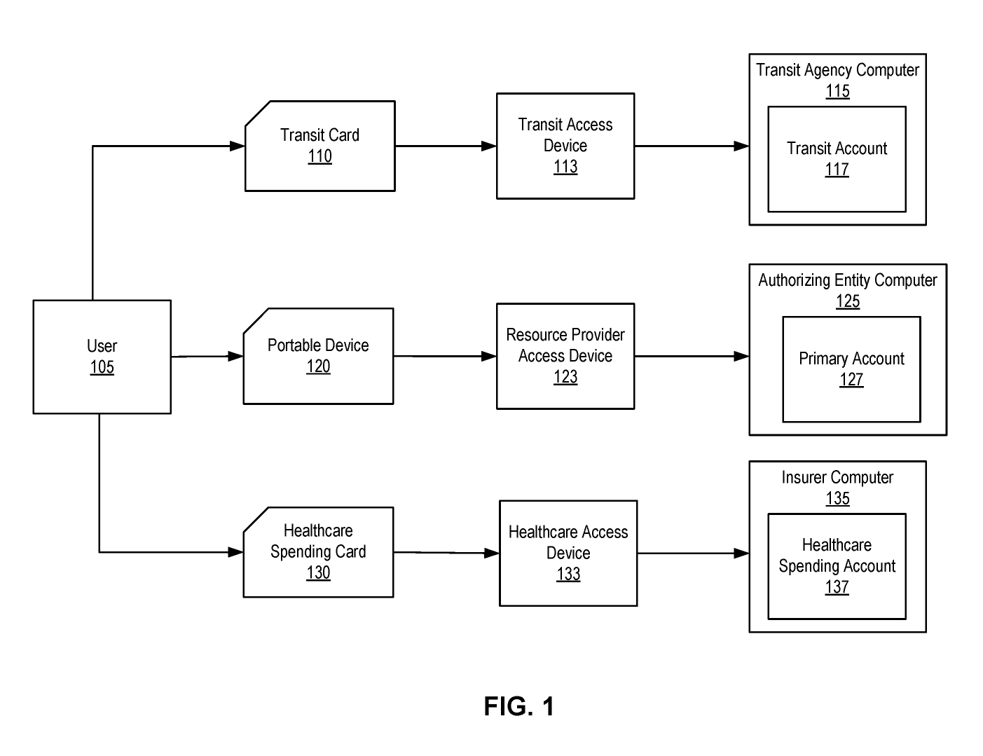

Many agencies employ closed loop systems that require users to maintain dedicated agency cards associated with accounts maintained by the agencies. For example, FIG. 1 shows a block diagram of a conventional closed loop system. User 105 has three payment devices: a transit card 110, a portable device 120, and a healthcare spending card 130.

Transit card 110 may be used by user 105 at a transit access device 113 (e.g., a gate, a turnstile, etc.). For example, user 105 may swipe or tap transit card 110 at the transit access device 113 to gain access to a transit station. Transit access device 113 may initiate a debit of transit account 117 for the cost of the transit, either upon user 105's entry to the transit station or upon user 105's exit from the transit station. Transit account 117 is held and operated by a transit agency 115. Transit account 117 may hold subsidized funds earmarked for transit expenses and/or unsubsidized funds. Transit agency 115 may be the operator of the transit station and the issuer of transit card 110.

Healthcare spending card 130 may be used by user 105 at a healthcare access device 133 (e.g., a POS device at a doctor's office). For example, user 105 may swipe or tap healthcare spending card 130 at the healthcare access device 133 to pay for healthcare-related or medical costs. Healthcare access device 133 may initiate a debit of healthcare spending account 137 for the healthcare-related expense. Healthcare spending account 137 is held and operated by an insurer 135, for example. Healthcare spending account 137 may hold subsidized funds earmarked for healthcare expenses. Insurer 135 may be the issuer of healthcare spending card 130.

Portable device 120 may be used by user 105 at a resource provider access device 123 (e.g., a POS device at a resource provider). For example, user 105 may swipe or tap portable device 120 at the resource provider access device 123 to pay for a resource (e.g., goods, services, etc.). In some embodiments, portable device 120 may be a credit card or a debit card. In some embodiments, portable device 120 is a communication device provisioned with a payment account. Resource provider access device 123 may initiate a debit of primary account 127 for the resource expense. Primary account 127 is held and operated by an authorizing entity 125, for example. Primary account 127 may hold unsubsidized funds that may be used for any purpose. Authorizing entity 125 may be the issuer associated with portable device 120.

As shown in FIG. 1, three separate cards are needed by user 105: a transit card 110 to access and pay for transit services, a healthcare spending card 130 to pay for healthcare expenses, and a portable device 120 to pay for general expenses. Transit card 110 cannot be used at resource provider access device 123 or healthcare access device 133, and healthcare spending card cannot be used at transit access device 113 or resource provider access device 123. Although portable device 120 may also be used in some examples to pay for transit services (e.g., at transit access device 113) and/or healthcare expenses (e.g., at healthcare access device 133), user 105 may prefer to use transit card 110 and/or healthcare spending card 130 to pay for such expenses, as funds in their associated accounts may be subsidized (e.g., paid for by an employer or taken out pre-tax). Primary account 127 may only hold unsubsidized funds in conventional systems.

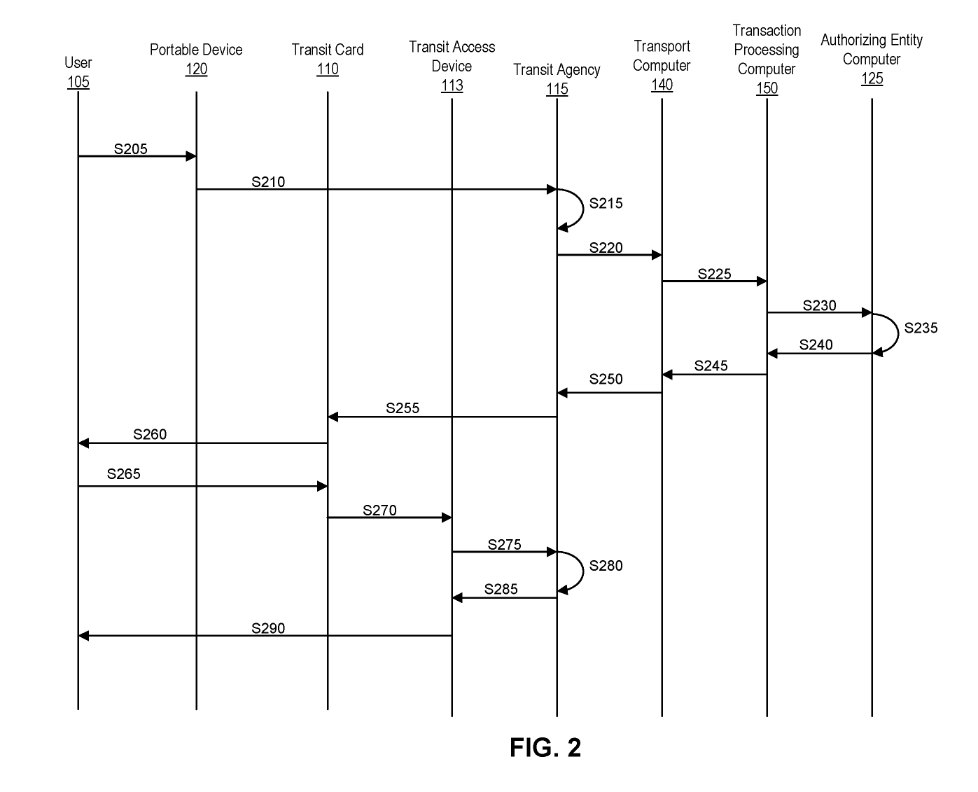

FIG. 2 shows a flow diagram of a conventional method for funding a closed loop transit card 110 (steps S205-S260) and processing a transaction using the closed loop transit card 110 (steps S265-S290) in a closed loop system. At step S205, user 105 accesses portable device 120 to fund a transit card 110. Portable device 120 may be, for example, a credit card or a debit card. In some examples, portable device 120 may be a communication device (e.g., a mobile device) provisioned with a payment account.

At step S210, portable device 120 is provided to transit agency 115 as a source of funds to add an amount of funds to the transit card 110. At step S215, the transit agency 115 generates an authorization request message for the amount of funds and includes details received from portable device 120 (e.g., a primary account number, a verification value, an expiration date, etc.). At step S220, transit agency 115 sends the authorization request message to transport computer 140, which may be, for example, a bank associated with transit agency 115. Transport computer 140 forwards the authorization request message to transaction processing computer 150 at step S225. At step S230, transaction processing computer 150 forwards the authorization request message to authorizing entity 125. Authorizing entity 125 may be an issuer associated with portable device 120.

At step S235, authorizing, entity 125 determines whether to authorize the transaction (e.g., whether there are sufficient funds in the account associated with portable device 120), and generates an authorization response message. At step S240, authorizing entity 125 sends the authorization response message to transaction processing computer 150. At step S245, transaction processing computer 150 sends the authorization response message to transport computer 140. At step S250, transport computer 140 forwards the authorization response message to transit agency 115. If the authorization response message indicates that the transaction is authorized, transit agency 115 loads the amount of funds on the transit card 110 at step S255. At step S260, user 105 is notified that the funds were successfully loaded on transit card 110 for use by user 105. Although shown and described as user 105 adding funds to transit card 110, it is contemplated that a third party (e.g., an employer) may instead be adding funds to transit card 110 for use by user 105 according to a similar method.

Thereafter, user 105 accesses transit card 110 to gain access to transit services at step S265. At step S270, user 105 uses transit card 110 at transit access device 113 (e.g., by swiping or tapping transit card 110 at a gate or turnstile). Transit access device 113 generates an internal authorization request with an identifier of the transit card 110 and a computed fare for user 105, and sends the internal authorization request to transit agency 115 at step S275. At step S280, transit agency 115 debits the transit account associated with transit card 110 for the fare. If the fare is successfully unloaded from transit card 110, transit agency 115 sends a success message to transit access device 113 at step S285. At step S290, transit access device 113 may allow user 105 access to the transit services (e.g., by opening the gate).

Thus, closed loop systems such as those used by transit agencies have many drawbacks. For example, a dedicated transit card is required that is associated with an account maintained by the transit agency. To add value to the transit card, open loop payment (i.e., through a traditional payment system comprising a payment processing network and an issuer) must be made using another portable device, such as a credit card, debit card or a provisioned communication device. When using the transit card, the fare may then be deducted from the balance associated with the transit card by the transit agency using a closed loop payment (i.e., through the transit agency). Thus, not only are two separate cards required to fund and use the transit system (e.g., a transit card and a credit card), but two separate processes must be used for funding the transit card (open loop) and using the transit card (closed loop). In addition, any unsubsidized funds added to the transit card are usually nonrefundable, even if they are not used.

### II. Dual Open-Closed Loop System

Embodiments of the invention improve upon traditional closed loop systems by providing a dual open-closed loop system that can utilize both restricted and unrestricted, open or normal transaction processing. A flag associated with a transaction may be used to determine a category of usage of a resource (e.g., unrestricted or restricted funds). In one example, earmarked subsidized funds can be used with restrictions using a traditional portable device or credential, without comingling subsidized funds and unsubsidized funds. Thus, a single portable device may be used to access both open funds and restricted funds. In addition, reduced processing power is needed as compared to a traditional transit system model, for example, as the transaction processor may maintain a blockchain evidencing transactions on the transit account instead of the transit agency. This may allow the transit agency to verify transactions and account balances instantaneously.

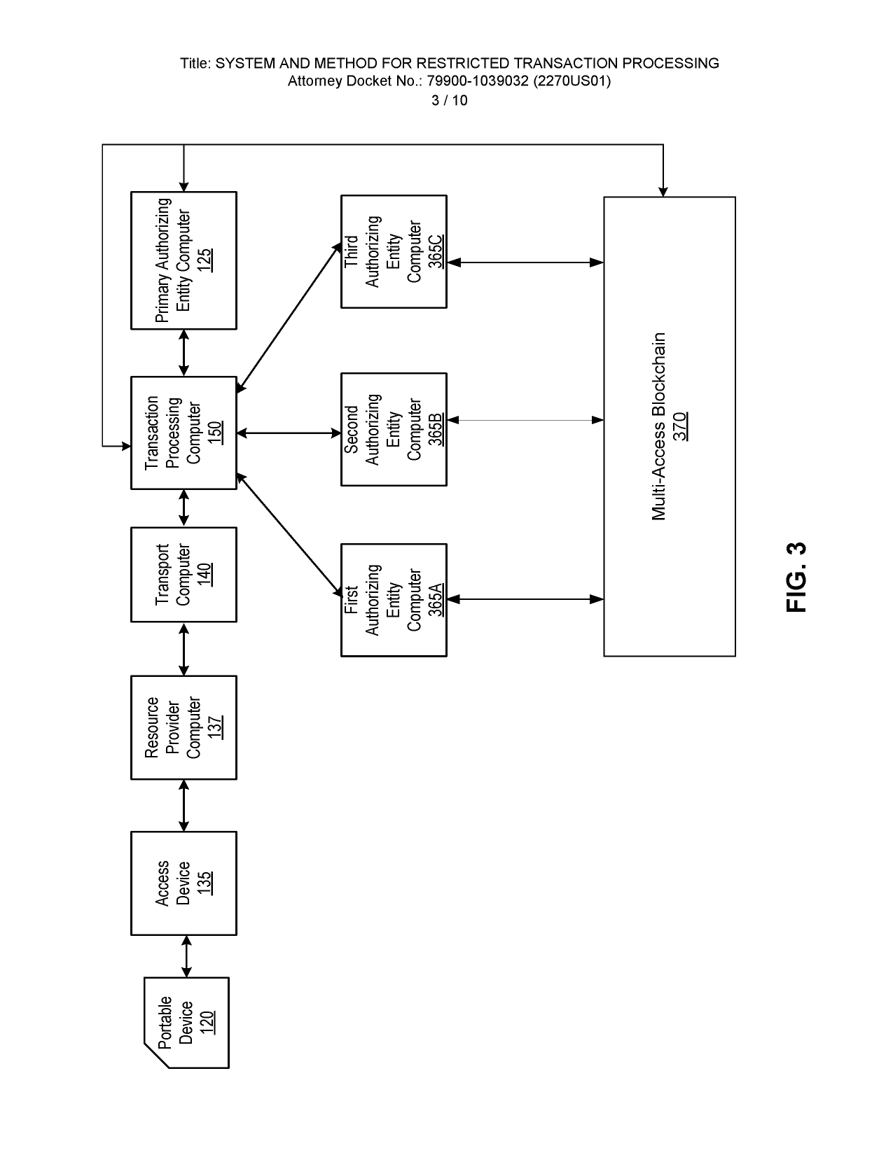

FIG. 3 shows a block diagram of a system for dual transaction processing according to embodiments of the present invention. The system includes a portable device 120, an access device 135, a resource provider computer 137, a transport computer 150, a transaction processing computer 150, a primary authorizing entity computer 125, a first authorizing entity computer 365A, a second authorizing entity computer 365B, a third authorizing entity computer 365C, and a multi-access blockchain 370. Each of these entities may be in communication with each other over a network for example.

In use, a user (not shown) may operate the portable device 120. For example, the portable device 120 may be swiped, tapped or waved by the user at the access device 135. The access device 135 may be any access device, including transit access device 113, resource provider access device 123, healthcare access device 133, and/or the like. The portable device 120 may interact with the access device 135 to initiate a transaction.

Access device 135 may be any device that provides access to a resource. Access device 135 may generally be located in any suitable location, such as at the location of a resource provider. Access device 135 may be in any suitable form. Examples include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, websites, and the like. Access device 135 may use any suitable contact or contactless mode of operation to send or receive data from, or associated with, a portable device (e.g., portable device 120). In some embodiments where access device 135 may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable device (e.g., portable device 120).

In some embodiments, access device 135 may be part of or in communication with a resource provider computer 137. Resource provider computer 137 may be a computer associated with any resource provider, such as a merchant, a transit agency, an insurer, an access provider, and/or the like. Such a computer may be configured to receive transaction data from access device 135. For example, a resource provider computer 137 may enable a resource provider such as a merchant to engage in transactions, sell goods or services, or provide access to goods or services to a user. The computer may accept multiple forms of payment and may use multiple tools to conduct different types of transactions. For example, a resource provider computer 137 may communicate with, include, or be an access device 135 at a physical store operated by a resource provider for in-person transactions. A resource provider computer 137 may also enable a resource provider to sell goods and/or services via a website, and may accept payments over the Internet. Access device 135 may comprise a server computer to facilitate performance of the transaction processing functions described herein. The server computer may include a processor and a computer readable medium coupled to the processor, the computer readable medium comprising code, executable by the processor.

Once a transaction has been initiated with portable device 120, access device 135 and/or resource provider computer 137 may generate an authorization request message for the transaction. The authorization request message may include a credential (e.g., an account number) associated with portable device 120, a transaction amount, and a flag specifying the category of the transaction (e.g., transit, healthcare, clothing, food, etc.). In some embodiments, the credential may be an electronic identifier (eID). An eID may be a universal identifier (containing any combination of letters, numbers, and/or symbols) that uniquely identifies an individual. The eID may be used in lieu of an account number to make the transaction more secure. For example, a primary account number (PAN) of a portable device may be protected from interception and/or fraud by unauthorized parties by instead using an eID, eliminating the need for transmission of sensitive information by multiple parties over a network.

Resource provider computer 137 may forward the authorization request message to transport computer 140. Resource provider computer 137 may comprise a server computer to facilitate performance of the transaction processing functions described herein. The server computer may include a processor and a computer readable medium coupled to the processor, the computer readable medium comprising code, executable by the processor.

In some embodiments, transport computer 140 is provided between the access device 135 and the transaction processing computer 150. The transport computer may be associated with an acquirer. An “acquirer” may typically be a business entity (e.g., a commercial bank) that has a business relationship with a particular resource provider (e.g., a merchant, a transit agency, an insurer, a healthcare provider, etc.) or other entity. In some embodiments, transport computer 140 is not provided. Some entities can perform both issuer and acquirer functions. Some embodiments may encompass such single entity issuer-acquirers. Transport computer 140 is configured to route authorization request messages from access device 135 to a transaction processing computer 150. Transport computer 140 may comprise a server computer to facilitate performance of the transaction processing functions described herein. The server computer may include a processor and a computer readable medium coupled to the processor, the computer readable medium comprising code, executable by the processor.

Transaction processing computer 150 may be associated with one or more payment service providers. Transaction processing computer 150 may be configured to determine the appropriate authorizing entity computer 365A, 365B, 3650, 125 associated with the credential and/or flag in the authorization request message, and to route the authorization request message to that authorizing entity computer 365A, 365B, 365C, 125. Transaction processing computer 150 may also comprise a server computer. The server computer may include a processor and a computer readable medium coupled to the processor, the computer readable medium comprising code, executable by the processor.

In use, the transaction processing computer 150 may receive an authorization request message including a value (e.g., a transaction amount), a credential (e.g., a PAN), and a flag. In some embodiments, the flag may be, for example, a code (e.g., “4111”) that corresponds to a particular category of transaction (e.g., transit). In some embodiments, the flag may be, for example, a merchant identifier that uniquely identifies a merchant. The merchant identifier may be used to determine the associated category of transaction. In some embodiments, the flag may be included in an existing field of an authorization request message (e.g., the merchant category code field), such that changes to the structure of existing authorization request messages are not needed.

The transaction processing computer 150 may determine that the flag is included in the request, and in response, determine an identity of the authorizing entity computer needed to process the transaction. The flag may be used by the transaction processing computer 150 to determine if the transaction is: (1) a dosed loop transaction with rollover to an open loop transaction (if needed), or (2) an open loop transaction. For example, if the flag is a category code that indicates transit, the transaction processing computer 150 may access a lookup table stored in a database to identify first authorizing entity computer 365A, which may be a closed loop transit agency, as being associated with that category code. In another example, if the flag indicates healthcare, the transaction processing computer 150 may identify second authorizing entity computer 365B, which may be a closed loop insurer. In still another example, if the flag indicates a particular resource provider, the transaction processing computer 150 may identify third authorizing entity computer 365C, which may be associated with that closed loop resource provider. If there are insufficient funds in the closed loop account, the remainder of the transaction may be run as an open loop transaction, as described further herein.

Else, in some embodiments, if the flag is not associated with first authorizing entity computer 365A, second authorizing entity computer 365B, or third authorizing entity computer 365C, or if there is no flag in the authorization request message, the transaction processing computer 150 may identify the open loop primary authorizing entity computer 125. The primary authorizing entity computer 125 may be identified based on the credential included in the authorization request message (i.e., the primary authorizing entity computer 125 may be associated with the issuer of the credential). The identification may be made by searching a lookup table in a database for the BIN included in the credential to determine an identity of the primary authorizing entity computer 125.

If the authorizing entity is identified as the first authorizing entity computer 365A, second authorizing entity computer 365B, or third authorizing entity computer 365C, the transaction processing computer 150 may verify that the transaction may be processed by the first authorizing entity computer 365A, second authorizing entity computer 365B, or third authorizing entity computer 365C (e.g., that the user and/or the credential is enrolled in a closed loop processing program and/or holds an account with the first authorizing entity computer 365A, second authorizing entity computer 365B, or third authorizing entity computer 365C).

In some embodiments, the transaction processing computer 150 may further translate the fields of the authorization request message into data and/or formatting usable by the first authorizing entity computer 365A, second authorizing entity computer 365B, or third authorizing entity computer 365C, as described further herein, in some embodiments. The transaction processing computer 150 may transmit the translated data to the first authorizing entity computer 365A, second authorizing entity computer 365B, or third authorizing entity computer 365C.

Meanwhile, the transaction processing computer 150 may use the transaction data to update the multi-access blockchain 370. The multi-access blockchain 370 may store data representing a plurality of interactions (e.g., transactions) between a plurality of authorizing entities and a plurality of users. The transaction processing computer 150 may calculate a balance that the user holds with the identified authorizing entity computer (e.g., first authorizing entity computer 365A) from the multi-access blockchain 370. The transaction processing computer 150 may make this calculation by summing up all of the transactions associated with an account number representing the user's account with the identified authorizing entity computer, as described further herein. The balance may be calculated as all of the unspent transaction outputs (UTXOs) on the users account, i.e., all of the transfers into the user's account that have not been used in transfers out of the user's account.

If the balance is greater than or equal to the transaction value, the transaction processing computer 150 may create an entry in the multi-access blockchain 370 that records the transaction for the transaction value. Thus, the transaction processing computer 150 may create entries in the multi-access blockchain 370 that result in decrements to a balance. In some embodiments, the first authorizing entity computer 365A, the second authorizing entity computer 365B, and/or the third authorizing entity computer 365C may create entries in the multi-access blockchain 370 that result in increments to a balance (e.g., reversals, returns, deposits, etc.).

As shown, it is contemplated that a single multi-access blockchain 370 may be implemented by and accessible to the first authorizing entity computer 365A, the second authorizing entity computer 3658, and the third authorizing entity computer 365C. In these embodiments, it is contemplated that different data corresponding to different authorizing entity computers may be distinguishable by data included in the blockchain. For example, one single blockchain may be maintained per credential across multiple authorizing entity computers holding different balances, with the particular authorizing entity computer and the particular balance being identified in each block. Further, it is contemplated that, in some embodiments, different authorizing entity computers may have access to blocks with which they are not associated (e.g., the first authorizing entity computer 365A may have access to blocks relating to transactions with the second authorizing entity computer 365B). However, in other embodiments, it is contemplated that the multi-access blockchain 370 may instead be separated, such that each authorizing entity computer has access to its own blockchain, with the transaction processing computer 150 having access to all of the blockchains.

If the authorizing entity is identified as the primary authorizing entity computer 125, the transaction processing computer 150 may forward the authorization request message to the primary authorizing entity computer 125. Primary authorizing entity computer 125 may communicate with the transaction processing computer 150 to conduct transactions. Primary authorizing entity computer 125 may also write decrements to the multi-access blockchain 370.

Primary authorizing entity computer 125 is typically run by a business entity (e.g., a bank) that may have issued the portable device 120, credentials or payment tokens used for the transactions. Some systems can perform both primary authorizing entity computer 125 and transport computer 140 functions. When a transaction involves a payment account associated with the primary authorizing entity computer 125, the primary authorizing entity computer 125 may verify the account and verify available funds in the account. Primary authorizing entity computer 125 may respond with an authorization response message to the transaction processing computer 150 which may be forwarded to the transport computer 140, the resource provider computer 137, the access device 135 and the portable device 120, if applicable. The primary authorizing entity computer 125 may comprise a server computer. The server computer may include a processor and a computer readable medium coupled to the processor, the computer readable medium comprising code, executable by the processor.

At a later time (e.g., at the end of the day), a clearing and settlement process can occur between the transport computer 140, the transaction processing computer 150, and the primary authorizing entity computer 125. Traditional clearing and settlement processes may not need to occur with the first authorizing entity computer 365A, second authorizing entity computer 365B, and/or third authorizing entity computer 365C as they are closed loop systems.

As one example, access device 135 may be a transit access device 113. A user may swipe or tap portable device 120 at the transit access device 113 to gain access to a transit station. The calculated fare may be $2. Transit access device 113 may generate an authorization request message using the credential associated with the portable device 120 (e.g., a PAN), the transaction value ($2), and a flag (e.g., a code representing transit). Transit access device 113 may transmit the authorization request message to a resource provider computer 137 (e.g., a transit agency computer). The resource provider computer 137 may transmit the authorization request message to the transport computer 140. The transport computer 140 may transmit the authorization request message to the transaction processing computer 150.

The transaction processing computer 150 may determine that the flag is present and that it is associated with transit. For example, the flag may be present as a merchant category code in the authorization request message of “4111”. The transaction processing computer 150 may access a lookup table in a database that correlates the merchant category code of “4111” with transit.

The transaction processing computer 150 may further identify the first authorizing entity computer 365A as being associated with transit. For example, the transaction processing computer 150 may access a lookup table in a database that correlates transit with the first authorizing entity computer 365A. In some embodiments, the transaction processing computer 150 may combine both of these steps. For example, the transaction processing computer 150 may determine that the flag is present and that the first authorizing entity computer 365A is associated with the flag. For example, the flag may be present as a merchant category code in the authorization request message of “4111”. The transaction processing computer 150 may access a lookup table in a database that correlates the merchant category code of “4111” to the first authorizing entity computer 365A.

In another example, the flag may be present as a merchant identifier in the authorization request message. An entity may enroll with the transaction processing computer 150 in order to be assigned a unique merchant identifier. When the entity initiates a transaction, the unique merchant identifier may be included in the authorization request message, and may be extracted by the transaction processing computer 150. The transaction processing computer 150 may access a lookup table in a database that correlates the unique merchant identifier to a particular category (e.g., transit) and/or to a particular authorizing entity computer 365A (e.g., first authorizing entity computer 365A).

The transaction processing computer 150 may further determine that the credential included in the authorization request message holds an account with the first authorizing entity computer 365A. For example, the transaction processing computer 150 may access a lookup table in a database that stores the credential in association with one or more closed loop account identifiers (e.g., an account number associated with and unique to the first authorizing entity computer 365A that may be different than the credential). Thus, the transaction processing computer 150 may forward the authorization request message to the first authorizing entity computer 365A. The transaction processing computer 150 may further create an entry recording the transaction in the multi-access blockchain 370. For example, the transaction processing computer 150 may record the transaction in a new block in the multi-access blockchain 370 with respect to the first authorizing entity computer 365A with a decrement of $2 reflected in the transaction (e.g., reducing the UTXO by $2).

As shown in FIG. 3, only one card is needed by the user: a portable device 120 to pay for closed loop purchases (e.g., transit, healthcare, etc.) and open loop purchases (e.g., general expenses). Portable device 120 may also be used at a plurality of closed loop and open loop access devices, such as transit access device 113, resource provider access device 123, and/or healthcare access device 133.

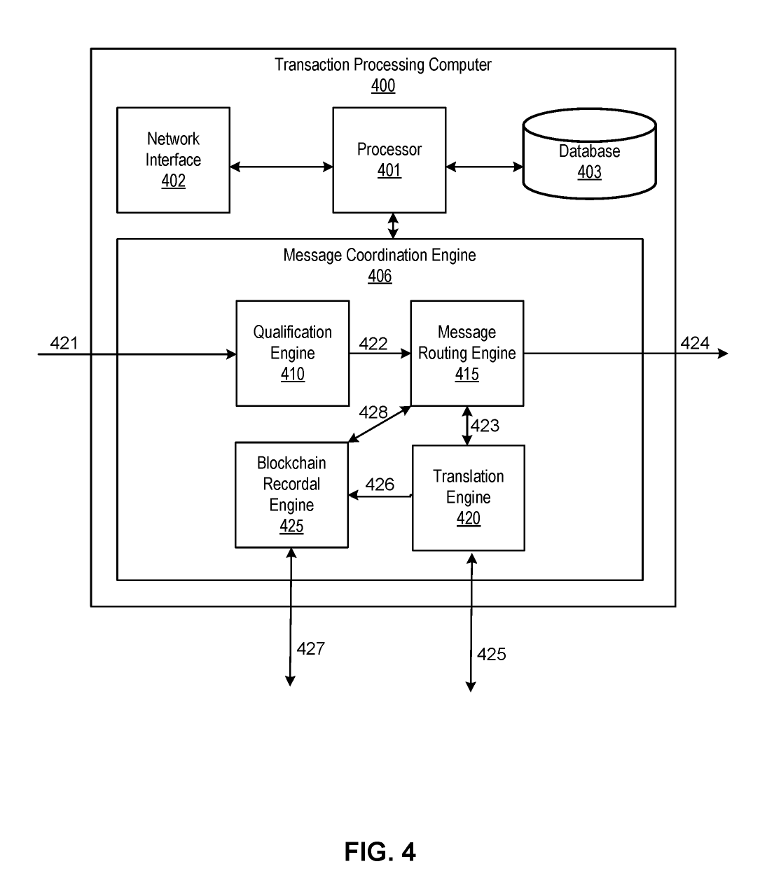

For simplicity of illustration, a certain number of components are shown in FIG. 3. It is understood, however, that embodiments of the invention may include more than one of each component. In addition, some embodiments of the invention may include fewer than or greater than all of the components shown in FIG. 4. In addition, the components in FIG. 3 may communicate via any suitable communication medium (including the Internet), using any suitable communication protocol.

FIG. 4 shows a block diagram of a transaction processing computer 400 according to some embodiments of the present invention. For example, transaction processing computer 400 can be transaction processing computer 150 of FIG. 3, that provides transaction processing and forwarding services for a plurality of users and a plurality of authorizing entities. Transaction processing computer 400 may include a processor 401 coupled to a network interface 402 and a message coordination engine 406. The message coordination engine 406 may be recorded on a computer readable medium. Transaction processing computer 400 may also include or otherwise have access to a database 403 that may be internal or external to transaction processing computer 400.

Processor 401 may include one or more microprocessors to execute program components for performing the open- and closed-loop transaction processing functions of transaction processing computer 400. Network interface 402 can be configured to connect to one or more communication networks to allow transaction processing computer 400 to communicate with other entities such as a transport computer, a multi-access blockchain, an authorizing entity, etc. The message coordination engine 406 may implemented on any combination of one or more volatile and/or non-volatile memories, for example, RAM, DRAM, SRAM. ROM, flash, or any other suitable memory components. The message coordination engine 406 may include code executable by the processor 401 for implementing some or all of the transaction processing and routing functions of transaction processing computer 400. For example, message coordination engine 406 may include code implementing a qualification engine 410, a message routing engine 415, and a translation engine 420.

In use, an authorization request message 421 is received from an entity (e.g., a transport computer) at the transaction processing computer 400 and routed to a qualification engine 410. The qualification engine 410 may, in conjunction with the processor 401, extract the credential (or any other identifying information) from the authorization request message 421. The qualification engine 410 may, in conjunction with the processor 401, determine whether the credential is enrolled in closed loop processing and/or holds an account with a closed loop authorizing entity. For example, the qualification engine 410 may extract the PAN “1234 5678 9012 3456” from the authorization request message 421. The qualification engine 410 may then, in conjunction with the processor 401, access a lookup table in the database 403 that includes a list of credentials and an indication of whether each credential is enrolled in closed loop processing, with which closed loop authorizing entities each credential has an account, and/or the like.

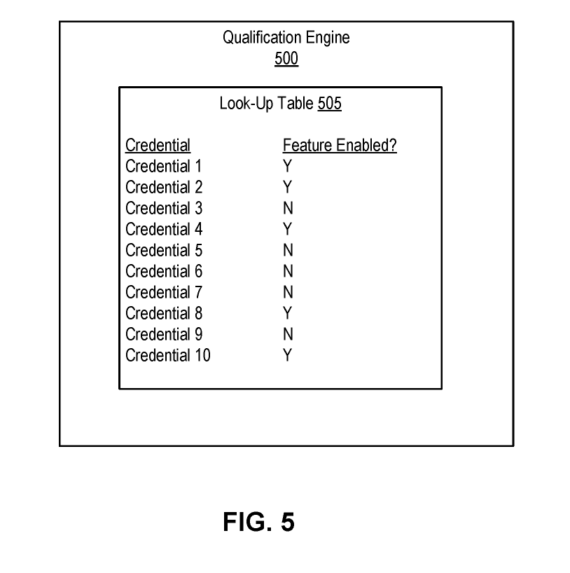

FIG. 5 shows a block diagram of a qualification engine 500 according to some embodiments of the present invention. Qualification engine 500 may be implemented as, for example, qualification engine 410 of FIG. 4. As shown in FIG. 5, qualification engine 500 may include a look-up table 505. The look-up table 505 may include a list of credentials and an indicator of whether each credential qualifies for closed loop processing. Although illustrated as a look-up table, it is contemplated that the credentials (and/or other identifying information) and their associated enrollment information can be stored or accessed by the qualification engine 500 in any format.

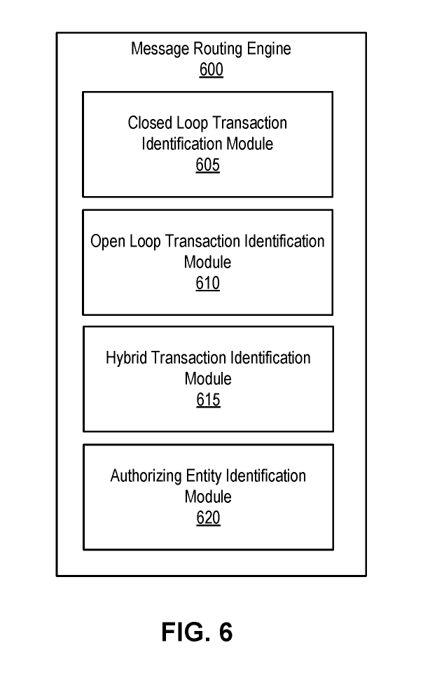

Turning back to FIG. 4, the qualification engine 410 may transmit an indicator 422 of whether the credential is qualified for closed loop processing to a message routing engine 415, along with the authorization request message. FIG. 6 shows a block diagram of a message routing engine 600 according to some embodiments of the present invention. Message routing engine 600 may be implemented as, for example, message routing engine 415 of FIG. 4. As shown in FIG. 6, message routing engine 600 may include a closed loop transaction identification module 605, an open loop transaction identification module 610, a hybrid transaction identification module 615, and an authorizing entity identification module 620. The closed loop transaction identification module 605, the open loop transaction identification module 610, the hybrid transaction identification module 615, and the authorizing entity identification module 620 may include code executable by the processor 401 for implementing some or all of the functions described herein.

The closed loop transaction identification module 605 may be configured to determine whether a particular authorization request message is associated with a closed loop transaction. For example, the closed loop transaction identification module 605 may extract a flag from the authorization request message. The flag may be, for example, a code (e.g., “4111”) that corresponds to a particular category of transaction (e.g., transit). The flag may be included in an existing field of an authorization request message (e.g., the merchant category code field), such that changes to the structure of existing authorization request messages are not needed. In some embodiments, the closed loop transaction identification module 605 may determine that the transaction is a closed loop transaction based on the presence of the flag in the authorization request message (i.e., if any flag is present, then the transaction is a closed loop transaction). In some embodiments, the closed loop transaction identification module 605 may determine that the transaction is a closed loop transaction based on the data included in the flag (i.e., certain data, such as a “1”, or certain values, such as “4111”, may indicate a closed loop transaction, while other data, such as a “0”, or certain values, such as “OPEN”, may indicate an open loop transaction).

The open loop transaction identification module 610 may be configured to determine whether a particular authorization request message is associated with an open loop transaction. For example, the open loop transaction identification module 610 may attempt to extract the flag from the authorization request message. In some embodiments, the open loop transaction identification module 610 may determine that the transaction is an open loop transaction based on the absence of the flag in the authorization request message (i.e., if no flag is present, then the transaction is an open loop transaction). In some embodiments, the open loop transaction identification module 610 may determine that the transaction is an open loop transaction based on the data included in the flag (e.g., certain data, such as “NO”, “0”, “1400”, etc., may indicate an open loop transaction). In some embodiments, the open loop transaction identification module 610 may automatically determine that an authorization request message is associated with an open loop transaction if the closed loop transaction identification module 605 determines that it is not associated with a closed loop transaction. In some embodiments, this determination may be made by the closed loop transaction identification module 605, and the open loop transaction identification module 610 may be omitted.

The hybrid transaction identification module 615 may be configured to determine whether a particular authorization request message is associated with a hybrid open- and closed-loop transaction. For example, a user may purchase a prescription and a magazine at a drugstore. The prescription may qualify for dosed loop processing from a health savings account, while the magazine only qualifies for open loop processing from a general account. Thus, an authorization request message may be generated that includes flags indicating both closed loop and open loop processing, with each flag having an associated value (e.g., $10.00 for the prescription via closed loop processing and $3.99 for the magazine via open loop processing). This is advantageous in that only one authorization request message is needed to process a hybrid transaction out of two separate portions of a single account, improving efficiency and resource usage.

In another example, a hybrid transaction may be generated for an otherwise closed loop transaction where the closed loop account has insufficient funds. In this example, the remaining dosed loop funds may be utilized first (e.g., $6 of a $9 transit fare), with the balance being taken from open loop funds (e.g., the remaining $3 of the transit fare). In the latter example, the authorization request message may not include flags indicating both dosed- and open loop transactions. Instead, the authorization request message may include a flag indicating a closed loop transaction, and upon identification of the closed loop authorizing entity and account, a determination may be made that insufficient funds are available in the closed loop account. The hybrid transaction identification module 615 may label the transaction as a hybrid transaction.

The authorizing entity identification module 620 may be configured to receive an indication of whether the authorization request message relates to an open loop and/or closed loop transaction from the closed loop transaction identification module 605, the open loop transaction identification module 610, and/or the hybrid transaction identification module 615. The authorizing entity identification module 620 may be configured to determine an identity of the authorizing entity computer needed to process the transaction. For example, if the flag indicates transit, the authorizing entity identification module 620 may identify a particular closed loop authorizing entity computer, which may be operated by a transit agency, by querying a lookup table stored in a database, as described further herein. If the flag indicates healthcare, the authorizing entity identification module 620 may identify another particular closed loop authorizing entity computer, which may be operated by the insurer. If the transaction is indicated as an open loop transaction (and/or there is no flag in the authorization request message), the authorizing entity identification module 620 may identify a primary authorizing entity computer associated with the credential included in the authorization request message. In a hybrid transaction (e.g., a transaction having multiple flags), the authorizing entity identification module 620 may identify both a closed loop authorizing entity using the flag and an open loop authorizing entity using the credential. For example, the authorizing entity identification module 620 may identify the closed loop authorizing entity by querying a lookup table stored in a database, as described further herein, and may identify the open loop authorizing entity by extracting the BIN from the credential and using the BIN to retrieve its identity from a database.

Turning back to FIG. 4, if the transaction (or a part, of the transaction) is an open loop transaction, the authorization request message 424 may be routed to the appropriate primary authorizing entity computer. The message routing engine 415 may further route the authorization request message 428 to the blockchain recordal engine 425 to post a decrement to the blockchain associated with the credential and the primary authorizing entity computer, as discussed further herein. If the transaction (or a part of the transaction) is a closed loop transaction, the authorization request message 423 may be routed to a translation engine 420 along with the identified closed loop authorizing entity.

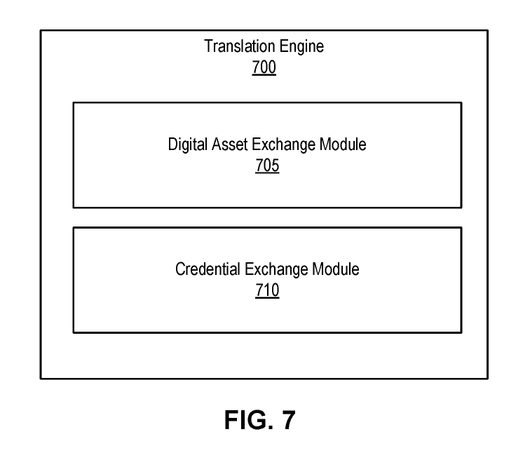

FIG. 7 shows a block diagram of a translation engine 700 according to some embodiments of the present invention. Translation engine 700 may be implemented by, for example, translation engine 420 of FIG. 4. Translation engine 700 may include a digital asset exchange module 705 and a credential exchange module 710.

The digital asset exchange module 705 may be configured to receive the authorization request message and extract the value of the transaction (e.g., $15). Based on the identity of the closed loop authorizing entity received from the message routing engine, the digital asset exchange module 705 may use a look up table or apply stored rules to convert from the currency used in the authorization request message to the currency used by the closed loop authorizing entity. For example, the authorization request message may include $15, which may correlate to two one-way commuter fare. Thus, the digital asset exchange module 705 may translate “$15” into “2”. It is contemplated that in some embodiments, the closed loop authorizing entity may use the same currency as that used in the authorization request message (e.g., dollars). In these embodiments, the digital asset exchange module 705 may be omitted.

The credential exchange module 710 may be configured to receive the authorization request message and extract the credential used for the transaction. Based on the identity of the closed loop authorizing entity received from the message routing engine, the credential exchange module 710 may use a look up table or apply stored rules to translate the credential into an account identifier used by the closed loop authorizing entity. In some embodiments, the account identifier may be identified using other information included in the authorization request message alternative to or in addition to the credential, such as a user's name. In some embodiments, the closed loop authorizing entity may use the credential as the account identifier. In these embodiments, the credential exchange module 710 may be omitted.

Turning back to FIG. 4, once the credential and/or the value in the authorization request message 423 has been translated, the authorization request message 423 may be updated with the translated values and the authorization request message 425 may be transmitted to the appropriate closed loop authorizing entity. The authorization request message 426 may also be transmitted to the blockchain recordal engine 425 to post a transaction 427 to the blockchain associated with the account identifier and the closed loop authorizing entity computer, as discussed further herein. The transaction 427 may indicate a decrement (e.g., a reduction in UTXO). In some embodiments, the blockchain may be maintained with the translated credential and/or value. In some embodiments, the blockchain may be maintained with the original credential and/or value.

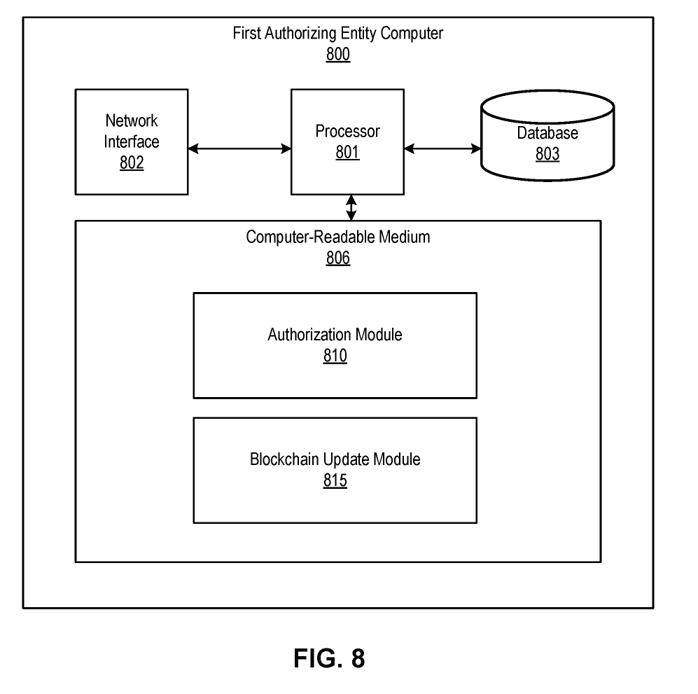

FIG. 8 shows a block diagram of a first authorizing entity computer 800 according to some embodiments of the present invention. For example, first authorizing entity computer 800 can be any of first authorizing entity computer 365A, second authorizing entity computer 365B, or third authorizing entity computer 365C of FIG. 3, that may act as an issuer of a closed loop account associated with a user. First authorizing entity computer 800 may include a processor 801 coupled to a network interface 802 and a computer-readable medium 806. First authorizing entity computer 800 may also include or otherwise have access to a database 803 that may be internal or external to first authorizing entity computer 800.

Processor 801 may include one or more microprocessors to execute program components for performing the authorization functions of first authorizing entity computer 800. Network interface 802 can be configured to connect to one or more communication networks to allow first authorizing entity computer 800 to communicate with other entities such as a transaction processing computer, a multi-access blockchain, etc. The computer-readable medium 806 may include any combination of one or more volatile and/or non-volatile memories, for example, RAM, DRAM, SRAM, ROM, flash, or any other suitable memory components. The computer-readable medium 806 may store code executable by the processor 801 for implementing some or all of the authorization functions of first authorizing entity computer 800. For example, computer-readable medium 806 may include code implementing an authorization module 810 and a blockchain update module 815.

The authorization module 810 may, in conjunction with the processor 801, receive authorization request messages from the transaction processing computer that include an account identifier and a value. The authorization module 810 may, in conjunction with the processor 801, access a multi-access blockchain associated with the account identifier and determine if there is a sufficient balance in the account to decrement the value. If there is a sufficient balance, the authorization module 810 may, in conjunction with the processor 801, authorize the transaction and transmit an instruction to the transaction processing computer to update the blockchain with the decrement. In some embodiments, the authorization function may be performed instead by the transaction processing computer, who may determine whether there are sufficient funds available in the blockchain and post the decrement to the account without further input from the first authorizing entity computer 800.

The blockchain update module 815 may, in conjunction with the processor 801, post increments to accounts on the multi-access blockchain associated with an account identifier. Such increments may include returns, reversals, credits, deposits, transfers, wires, combinations thereof, and the like. Increments may be added to the blockchain by any method, such as by payment from a primary or open loop account into the closed loop account.

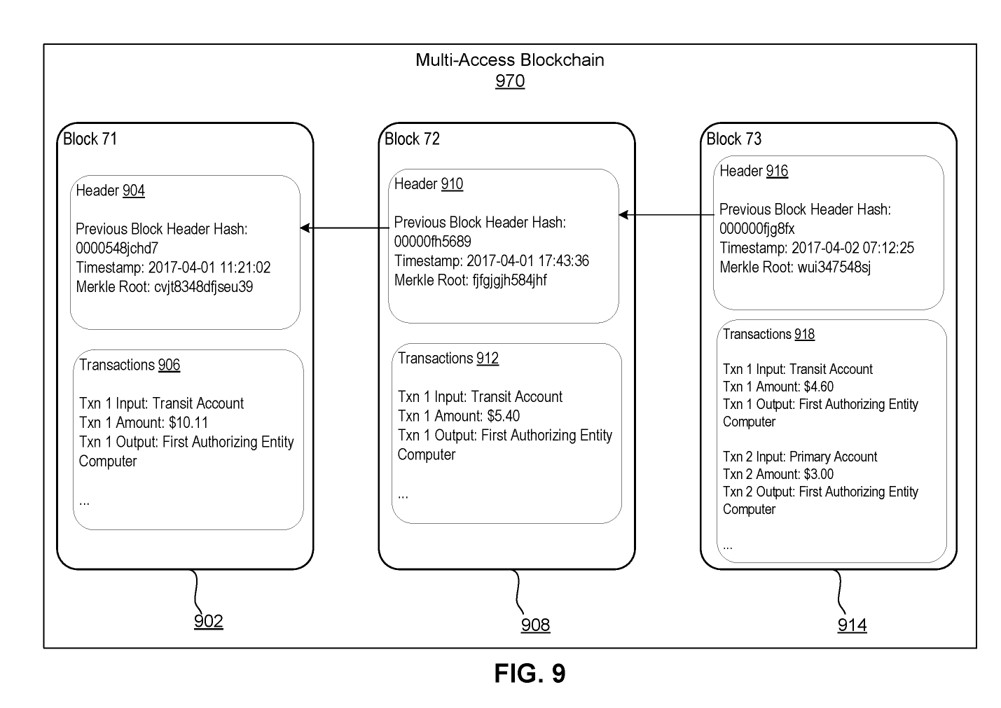

FIG. 9 shows a block diagram of a multi-access blockchain 970 according to some embodiments of the present invention. Multi-access blockchain 970 may be used, for example, to implement multi-access blockchain 370 of FIG. 3. Multi-access blockchain 970 illustrates three consecutive blocks in an exemplary blockchain: block 902, block 908, and block 914. The blockchain 970 may be an ordered, linked list of blocks. Each block 902, 908, 914 may be a data structure that aggregates transactions for inclusion in the blockchain 970. Each block may include a header and a list of transactions. For example, block 902 may include header 904 and transactions 906. Block 908 may include header 910 and transaction 912. Block 914 may include header 916 and transactions 918.

Headers 904, 910, 916 may include at least three sets of metadata: a previous block header hash, a timestamp, and a merkle root. The previous block header hash may connect each block to the previous block. For example, in header 910 of block 908, “00000fh5689” may be a hash of header 904 of block 902. In other words, a cryptographic hashing algorithm (e.g., SHA256) may be applied any number of times to the header 904 to obtain the value “00000fh5689”, which may be included in the header 910 of the block 908. The timestamp may be the creation time of the block. For example, block 908 may have been created on Apr. 1, 2017 at 5:43:36 PM. The merkle root may be a hash of the root of the merkle tree of each block's transactions. A merkle tree may be a summary of all of the transactions in a block that is constructed by hashing pairs of nodes until there is only one hash. The last remaining hash is the merkle root.

Transactions 906, 912, 918 may include at least three sets of metadata per transaction: an input, an amount, and an output. Transactions 906, 912, 918 may be data structures that encode a transfer of value from the input and the output In some embodiments, a plurality of inputs and/or a plurality of outputs may be specified. The input may be the source of the value to be transferred. The amount may be the value to be transferred. The output may be the destination of the value to be transferred. Previous unspent outputs to the multi-access blockchain 970 (i.e., values from an entity or user to the multi-access blockchain 970 that have not yet been used as input elsewhere) may result in unspent transaction output (UTXO). This UTXO may be used as input from the multi-access blockchain 970 to other entities or users. As shown in FIG. 9, there may be no cumulative balance maintained by the multi-access blockchain 970; instead, the available balance may be scattered as UTXO amongst a plurality of transactions and a plurality of blocks.

For example, transactions 906 may include a single transaction sent from a users closed loop transit account to a first authorizing entity computer (e.g., operated a transit agency) in the amount of $10.11. Transactions 912 may include a single transaction sent from a user's closed loop transit account to the first authorizing entity computer in the amount of $5.40. Transactions 918 may include two transactions: a first transaction sent from a user's closed loop transit account to the first authorizing entity computer in the amount of $4.60, and a second transaction sent from a user's primary account (e.g., an open loop account) to the first authorizing entity computer in the amount of $3.00. Transactions 918 may result, for example, because of insufficient UTXO in the transit account blockchain, causing the balance of the transit fare to be withdrawn from the primary account.

Although only illustrating transactions that decrement the UTXO of a user's blockchain in FIG. 9, it is contemplated that transaction that increment the UTXO may be similarly posted to a user's blockchain. An increment may include a similar header with similar types of metadata. However, the transaction metadata may be reversed. For example, the transaction input may be the entity funding the blockchain (e.g., a transit agency) and the transaction output may be associated with the user (e.g., a user's transit account). The transaction amount may be the amount of UTXO to add to the blockchain.

Implementing a multi-access blockchain 970 in lieu of a traditional database in the disclosed embodiments has many advantages. The multi-access blockchain 970 may allow for decentralized and/or shared control of the blockchain. For example, as shown in FIG. 3, multiple authorizing entity computers and/or a transaction processing computer may all have access to the blockchain, allowing each entity to verify transactions on multiple accounts that may be interrelated. For example, a transit agency requiring a $5 fare may confirm that an additional $2 was decremented from a user's open loop account where only $3 was present in the user's transit account This allows for transparency between entities and ecosystem simplification by adding all transactions to a single blockchain. This decentralization also prevents malicious attacks as the multi-access blockchain 970 does not have a central point of failure. In addition, the data written to the multi-access blockchain 970 may be unable to be changed, replaced and/or updated once it is written, reducing the possibility of fraud and errors. The multi-access blockchain 970 may also allow for faster transactions (e.g., by reducing clearing and settlement times to minutes instead of days) and lower transaction costs (e.g., by eliminating third party intermediaries and overhead costs).

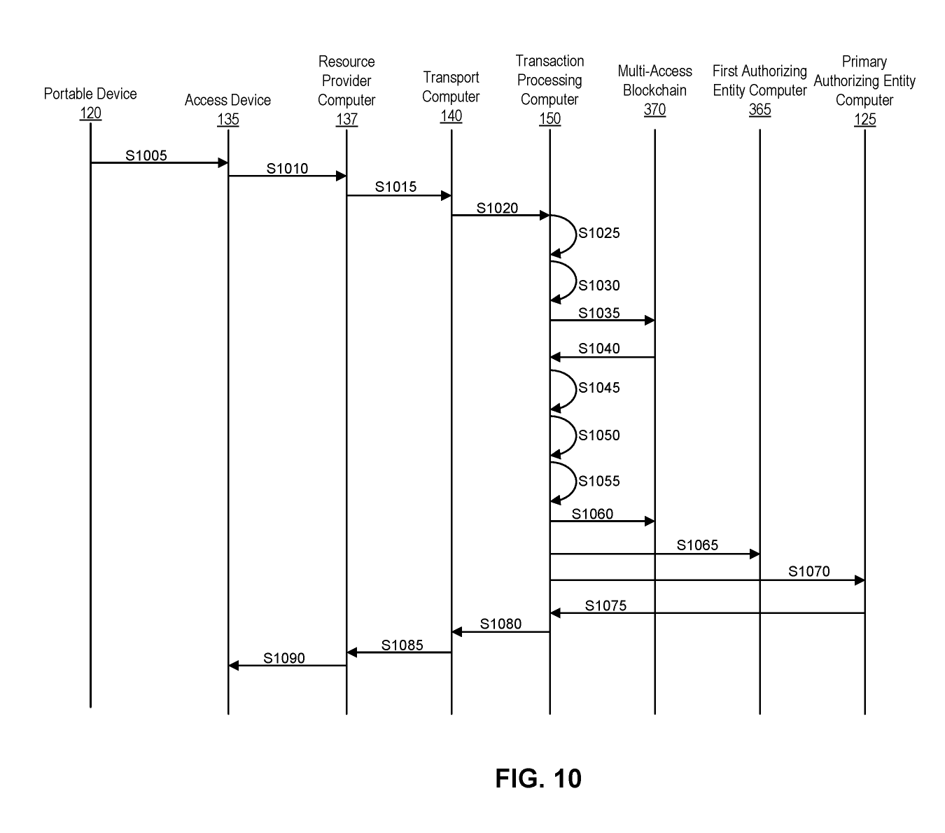

FIG. 10 shows a flow diagram of a method for dual transaction processing according to some embodiments of the present invention. The method may be performed by a portable device 120, an access device 135, a resource provider computer 137, a transport computer 140, a transaction processing computer 150, a multi-access blockchain 370, a first authorizing entity computer 365, and a primary authorizing entity computer 125. The first authorizing entity computer 365 may be implemented as any of the first authorizing entity computer 365A, the second authorizing entity computer 365B, and/or the third authorizing entity computer 365C.

At step S1005, a user may access a portable device 120 and may use the portable device 120 to interact with an access device 135. For example, portable device 120 may be swiped, waved or tapped at access device 135. Access device 135 may be any access device, including any of the access devices described herein (e.g., transit access device 113, resource provider access device 123, healthcare access device 133, etc.). The interaction may be, for example, a request for a transaction between the user and the first authorizing entity computer 365.

At step S1010, the access device 135 may generate an authorization request message for the transaction and transmit the authorization request message to the resource provider computer 137. The authorization request message may at least include a first value (e.g., a transaction amount, a fare amount, etc.), a credential associated with portable device 120 (e.g., an account number), and a flag. In some embodiments, the credential may be an eID. The flag may specify a category for the transaction (e.g., transit, healthcare, a resource provider identifier, a resource provider type, etc.). The flag may be generated by the access device 135 based on the type of the access device (e.g., a transit access device, healthcare access device, etc.), a type of goods or services being transacted for (e.g., a doctors visit, a transit fare, etc.), and the like. In some embodiments, the flag may be omitted from the authorization request message unless it corresponds to a particular category for which closed loop processing may be provided (e.g., a subsidized portion such as transit or healthcare, or another restricted portion such as a certain resource provider, etc.). In some embodiments, the authorization request message generated by access device 135 may omit the flag, and the flag may be provided by another entity, such as the resource provider computer 137 or the transaction processing computer 150. The flag may be provided in a certain category (e.g., 0 or 1), or as a code in a certain field indicating a particular category (e.g., “4112”). In some embodiments, the flag may be provided in an existing authorization request message field, such as the merchant category code (MCC), the merchant verification value (MVV), service indicator, combinations thereof, and/or the like.

At step S1015, the resource provider computer 137 may send the authorization request message to the transport computer 140. At step S1020, the transport computer 140 may forward the authorization request message to the transaction processing computer 150. In some embodiments, the flag may be omitted from the authorization request message received by transaction processing computer 150. In some embodiments, transaction processing computer 150 may determine whether and/or which flag should have been included and/or modify the authorization request message to include the flag based on other information contained in or associated with the authorization request message, such as an access device identifier, a resource provider identifier, a good or services identifier, and the like.

At step S1025, the transaction processing computer 150 may determine that the flag is in the authorization request message. At step S1030, the transaction processing computer 150 may determine an identity of the first authorizing entity computer 365 using the flag. For example, if the flag corresponds to transit, the transaction processing computer 150 may determine the first authorizing entity computer 365 that corresponds to the transit agency.

At step S1035, the transaction processing computer 150 may access the multi-access blockchain 370 to obtain a second value associated with the first authorizing entity computer 365 and the user, the portable device 120, the credential, and/or an account identifier associated with the user. The multi-access blockchain 370 may store data representing a plurality of interactions between a plurality of authorizing entity computers and a plurality of users. The second value may be the UTXO associated with the blockchain of the user and the first authorizing entity computer 365. At step S1040, the multi-access blockchain 370 may return the second value to the transaction processing computer 150.

At step S1045, the transaction processing computer 150 may determine that the second value (e.g., the UTXO) is less than the first value (e.g., the transaction amount). Thus, at step S1050, the transaction processing computer 150 may determine a primary authorizing entity computer 125 based on the credential in the authorization request message. The primary authorizing entity computer 125 may be associated with an open loop authorizing entity that is capable of authorizing transactions regardless of category. The primary authorizing entity computer 125 may be the issuer of the portable device 120.

At step S1055, the transaction processing computer 150 may determine that the primary authorizing entity computer 125 is capable of authorizing a third value that is the difference between the first value and the second value. In other words, the transaction processing computer 150 may determine whether the primary authorizing entity computer 125 is capable of authorizing the balance of the first value that could not be paid from the account with the first authorizing entity computer 365. In some embodiments, the transaction processing computer 150 may make this determination by transmitting a query to the primary authorizing entity computer 125. In some embodiments, the transaction processing computer 150 may make this determination by accessing the multi-access blockchain 370 for the UTXO associated with the credential and the primary authorizing entity computer 125.

At step S1060, the transaction processing computer 150 may create an entry recording the interaction in the multi-access blockchain 370. The entry may include the second value and the third value. The second value and the third value may be recorded in the multi-access blockchain 370 as separate transactions in a single block (e.g., as in block 914 of FIG. 9). At step S1065, the transaction processing computer 150 may send a message confirming the transaction to the first authorizing entity computer 365. An authorization response message from first authorizing entity computer 365 may not be needed in some embodiments, as the transaction processing computer 150 has already updated the account associated with the first authorizing entity computer 365 on the multi-access blockchain 370.

At step S1070, in some embodiments, the transaction processing computer 150 may send a message confirming the transaction to the primary authorizing entity computer 125. The primary authorizing entity computer 125 may generate and send an authorization response message to the transaction processing computer 150 at step S1075 that may confirm the entry in the multi-access blockchain 370. At step S1080, the transaction processing computer 150 may forward the authorization response message to the transport computer 140 (e.g., with respect to the third value), along with a response message indicating successful completion of the closed loop transaction (e.g., with respect to the second value). At step S1085, the transport computer 150 may forward the response messages to the resource provider computer 137. At step S1090, the resource provider computer 137 may forward the response messages to the access device 135. If the response messages indicate that the transactions are authorized, the access device 135 may allow access to a resource by the user. For example, if the transaction is for access to a venue or transit station, access device 135 may open a gate or turnstile.

At a later time (e.g., at the end of the day), a clearing and settlement process (i.e., fulfillment) can occur between the transport computer 140, the transaction processing computer 150, and the first authorizing entity computer 365, and the primary authorizing entity computer 125. Clearing may be initiated by transport computer 140 to inform primary authorizing entity computer 125 about the transaction performed by the user. In settlement, primary authorizing entity computer 125 may bill the transaction amounts to the appropriate accounts and can settle its debt with transport computer 140. In other words, funds may be transferred from the appropriate account at the primary authorizing entity computer 125 to transport computer 140. In some embodiments, the clearing records may be confirmed from the multi-access blockchain.

More specifically, during clearing, access device 135 may transmit the transaction record to transport computer 140. Transport computer 140 may generate a financial notification message from the transaction record, as well as a clearing batch file with all of the financial notification messages intended for primary authorizing entity computer 125. The financial notification message may include a unique transaction reference number. Transport computer 150 may then transmit the clearing batch file to the transaction processing computer 150. Transaction processing computer 150 may route the batch file to primary authorizing entity computer 125.

Primary authorizing entity computer 125 may extract the transaction reference number from the financial notification message and match the message against the original authorization request message. From the original authorization request message, primary authorizing entity computer 125 retrieves the primary account number (PAN) associated with the transaction. Primary authorizing entity computer 125 may calculate the total amount to charge to the account of the user. The total amount may then be directly debited from the account of the user. Primary authorizing entity computer 125 may then be considered reimbursed by the user.

Primary authorizing entity computer 125 may then route the funds to transaction processing computer 150. Transaction processing computer 150 may route the funds to transport computer 140. Transport computer 140 may then credit the amount of funds to the account associated with access device 135, completing the settlement process. These processes may not be necessary with respect to first authorizing entity computer 365, as it is part of a closed loop processing system (i.e., the funds are credited from an account held with the first authorizing entity computer 365 back to the first authorizing entity computer 365).

A computer system may be used to implement any or all of the entities or components described above. The subsystems of the computer system may be interconnected via a system bus. Additional subsystems such as a printer, keyboard, fixed disk (or other memory comprising computer readable media), monitor, which is coupled to display adapter, and others may be used. Peripherals and input/output (I/O) devices, which couple to an I/O controller (which can be a processor or other suitable controller), can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Peri or Python using, for example. conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed:

1. A method comprising:
receiving, at a server computer, a request to process an interaction between a user and a first authorizing entity computer, the request including a first value, a credential, and a flag;
determining, by the server computer, that the flag is in the request;
in response to determining that the flag is in the request, determining, by the server computer, an identity of the first authorizing entity computer using the flag;
accessing, by the server computer, a multi-access blockchain, the multi-access blockchain storing data representing a plurality of interactions between a plurality of authorizing entity computers and a plurality of users;
retrieving, by the server computer, a second value associated with the user and the first authorizing entity computer from the multi-access blockchain based on the identity;
determining, by the server computer, that the second value is less than the first value;
determining, by the server computer, a primary authorizing entity computer based on the credential:
determining, by the server computer, that the primary authorizing entity computer is capable of authorizing a third value, wherein the third value is the difference between the first value and the second value;
creating, by the server computer, an entry recording the interaction in the multi-access blockchain, wherein the entry includes the second value and the third value; and facilitating, by the server computer, processing of the third value by the primary authorizing entity computer.

2. The method of claim 1, wherein the credential includes an EID.

3. The method of claim 1, further comprising:
translating the credential into an account identifier associated with the user and the first authorizing entity computer, wherein the account identifier is used to retrieve the second value associated with the user and the first authorizing entity computer from the multi-access blockchain.

4. The method of claim 1, further comprising:
coordinating fulfillment of the third value from the primary authorizing entity computer to the first authorizing entity computer.

5. The method of claim 1, wherein the user initiates a funding request to associate a fourth value with the user and the first authorizing entity computer, and wherein the first authorizing entity computer thereafter creates a new entry recording the fourth value in the multi-access blockchain.

6. The method of claim 5, wherein the funding request is fulfilled by the primary authorizing entity computer to the first authorizing entity computer.

7. The method of claim 1, wherein the primary authorizing entity computer is implements open loop processing, and wherein the first authorizing entity computer implements closed loop processing.

8. The method of claim 1, wherein the primary authorizing entity computer is associated with an issuer of the credential.

9. The method of claim 1, wherein the first authorizing entity computer is associated with an entity identified by the flag.

10. A server computer comprising:
a processor; and
a memory coupled to the processor, the memory storing instructions, which when executed by the processor, cause the server computer to perform operations including:
receiving, at a server computer, a request to process an interaction between a user and a first authorizing entity computer, the request including a first value, a credential, and a flag;
determining, by the server computer, that the flag is in the request;
in response to determining that the flag is in the request, determining, by the server computer, an identity of the first authorizing entity computer using the flag;
accessing by the server computer, a multi-access blockchain, the multi-access blockchain storing data representing a plurality of interactions between a plurality of authorizing entity computers and a plurality of users;
retrieving, by the server computer, a second value associated with the user and the first authorizing entity computer from the multi-access blockchain based on the identity;
determining, by the server computer, that the second value is less than the first value;
determining, by the server computer, a primary authorizing entity computer based on the credential;
determining, by the server computer, that the primary authorizing entity computer is capable of authorizing a third value, wherein the third value is the difference between the first value and the second value;
creating, by the server computer, an entry recording the interaction in the multi-access blockchain, wherein the entry includes the second value and the third value; and
facilitating, by the server computer, processing of the third value by the primary authorizing entity computer.

11. The server computer of claim 10, wherein the credential includes an EID.

12. The server computer of claim 10, wherein the operations further include:
translating the credential into an account identifier associated with the user and the first authorizing entity computer, wherein the account identifier is used to retrieve the second value associated with the user and the first authorizing entity computer from the multi-access blockchain.

13. The server computer of claim 10, wherein the operations further include:
coordinating fulfillment of the third value from the primary authorizing entity computer to the first authorizing entity computer.

14. The server computer of claim 10, wherein the user initiates a funding request to associate a fourth value with the user and the first authorizing entity computer, and wherein the first authorizing entity computer thereafter creates a new entry recording the fourth value in the multi-access blockchain.

15. The server computer of claim 14, wherein the funding request is fulfilled by the primary authorizing entity computer to the first authorizing entity computer.

16. The server computer of claim 10, wherein the primary authorizing entity computer is implements open loop processing, and wherein the first authorizing entity computer implements closed loop processing.

17. The server computer of claim 10, wherein the primary authorizing entity computer is associated with an issuer of the credential.

18. The server computer of claim 10, wherein the first authorizing entity computer is associated with an entity identified by the flag.
